(19) United States
(12) Patent Application Publication
(10) Pub. No.: US 2024/0384638 A1
(43) Pub. Date: Nov. 21, 2024

(54) METHODS FOR MAINTAINING THE CONDUCTIVITY OF SUBTERRANEAN FORMATIONS FOLLOWING STIMULATION

(71) Applicants: SAUDI ARABIAN OIL COMPANY, Dhahran (SA); KING FAHD UNIVERSITY OF PETROLEUM & MINERALS, Dhahran (SA)

(72) Inventors: Mahmoud Hassan DESOUKY, Dhahran (SA); Yevgeniy SAMARKIN, Dhahran (SA); Murtada Saleh ALJAWAD, Dhahran (SA); Murtadha J. ALTAMMAR, Dhahran (SA); Khalid Mohammed ALRUWAILI, Dhahran (SA)

(73) Assignees: SAUDI ARABIAN OIL COMPANY, Dhahran (SA); KING FAHD UNIVERSITY OF PETROLEUM & MINERALS, Dhahran (SA)

(21) Appl. No.: 18/319,188

(22) Filed: May 17, 2023

(51) Int. Cl. E21B 43/27; C09K 8/84

(52) U.S. Cl. CPC E21B 43/27; C09K 8/845

(57) ABSTRACT

Methods for stimulating a subterranean formation and maintaining the conductivity therein may comprise: stimulating a subterranean formation comprising a carbonate mineral by performing matrix acidizing, hydraulic fracturing, or acid-fracturing upon the subterranean formation to form a plurality of flow pathways; after forming the plurality of flow pathways, introducing an ammonium phosphate salt in an aqueous carrier fluid into the subterranean formation; and interacting the carbonate mineral with the ammonium phosphate salt to convert at least a portion of the carbonate mineral into a hydroxyapatite mineral. The subterranean formation, after interacting with the ammonium phosphate salt, has an increased conductivity relative to the subterranean formation, after stimulating but before interacting with the ammonium phosphate salt, under a closure stress of about 600 psi or greater.

### FIELD OF THE DISCLOSURE

The present disclosure relates generally to subterranean stimulation operations and, more particularly, to chemical consolidation for maintaining conductivity following a stimulation operation.

### BACKGROUND OF THE DISCLOSURE

Stimulation operations are commonly used during oil and gas production to improve the productivity of a subterranean formation by increasing the permeability of the formation matrix. Common stimulation operations include hydraulic fracturing, matrix acidizing, or acid-fracturing techniques.

Hydraulic fracturing may introduce a fluid into a subterranean formation at a high pressure to generate flow pathways, commonly referred to fractures, within the formation matrix. The fractures may increase the permeability of the subterranean formation and improve hydrocarbon production. Hydraulic fracturing operations commonly utilize particulates, referred to as proppants, to keep the fractures open after the hydraulic pressure is released. Matrix acidizing, in contrast, generates porosity within a subterranean formation by dissolving a portion of the formation matrix to generate flow pathways, commonly referred to as wormholes, therein. Acid-fracturing operations may combine aspects of both hydraulic fracturing and matrix acidizing operations to increase the permeability of a subterranean formation.

Although hydraulic fracturing and matrix acidizing may desirably increase the permeability of a subterranean formation, these operations are not without their difficulties. In soft or ductile subterranean formations, proppants may become embedded within a fracture, thereby reducing the effective fracture width. The term “embedment” and other grammatical forms thereof refers to the process whereby proppant particulates become at least partially pushed into the formation matrix when placed under compressive stress (closure stress) within a fracture, thereby decreasing the effective fracture width compared to the width of the fully open fracture. Indeed, the decrease in conductivity under high closure stress may be significant. Matrix acidizing may further weaken the mechanical integrity of the formation matrix and lead to collapse of wormholes or even decrease the native permeability of the formation matrix itself. Acid may also weaken fracture asperities in acid-fracturing operations and lead to at least partial fracture closure, even if the subterranean formation itself is not overly soft or ductile on the whole. Regardless of origin, the foregoing types of subterranean formation damage may decrease hydrocarbon production or conductivity resulting from a stimulation operation due to a sub-optimal increase in permeability being realized over extended periods of time. Formation damage of the foregoing types may be especially prevalent when stimulating subterranean formations comprising a carbonate mineral.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to embodiments consistent with the present disclosure, methods for stimulating a subterranean formation and maintaining the conductivity therein comprise: stimulating a subterranean formation comprising a carbonate mineral by performing matrix acidizing, hydraulic fracturing, or acid-fracturing upon the subterranean formation to form a plurality of flow pathways; after forming the plurality of flow pathways, introducing an ammonium phosphate salt in an aqueous carrier fluid into the subterranean formation; and interacting the carbonate mineral with the ammonium phosphate salt to convert at least a portion of the carbonate mineral into a hydroxyapatite mineral. The subterranean formation, after interacting with the ammonium phosphate salt, has an increased conductivity relative to the subterranean formation, after stimulating but before interacting with the ammonium phosphate salt, under a closure stress of about 600 psi or greater.

In other embodiments consistent with the present disclosure, methods for stimulating a subterranean formation and maintaining the conductivity therein over a period of time comprise: stimulating a subterranean formation comprising a carbonate mineral by performing matrix acidizing, hydraulic fracturing, or acid-fracturing upon the subterranean formation to form a plurality of flow pathways; after forming the plurality of flow pathways, introducing an ammonium phosphate salt in an aqueous carrier fluid into the subterranean formation; and interacting the carbonate mineral with the ammonium phosphate salt to convert at least a portion of the carbonate mineral into a hydroxyapatite mineral. The subterranean formation, after interacting with the ammonium phosphate salt, has an increased conductivity relative to the subterranean formation, after stimulating but before interacting with the ammonium phosphate salt, and the conductivity of the subterranean formation, after interacting with the ammonium phosphate salt, varies by about 5% or less over a period of 2 days to 7 days under a closure stress of about 600 psi or greater.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a graph of conductivity as a function of closure stress for an acid-etched Austin chalk sample before and after treatment with diammonium hydrogen phosphate.

FIG. 2 is a graph of conductivity as a function of time for an acid-etched Austin chalk sample before and after treatment with diammonium hydrogen phosphate under various closure stresses. The untreated sample was measured under an 800 psi closure stress, and the treated sample was measured under a 1400 psi closure stress.

### DETAILED DESCRIPTION

Embodiments in accordance with the present disclosure generally relate to subterranean stimulation operations and, more particularly, to chemical consolidation for maintaining conductivity following a stimulation operation.

The present disclosure addresses the difficulties associated with stimulating soft and ductile formations, such as subterranean formations comprising a carbonate mineral, as well as weakening of the formation matrix that occurs upon stimulation. In particular, the present disclosure addresses the foregoing issues by increasing the hardness of the carbonate mineral within the subterranean formation, thereby increasing the mechanical strength of the formation matrix to retain permeability and conductivity following a stimulation operation. Increasing the hardness of the carbonate mineral may take place through chemical consolidation, as discussed in more detail below. Increased conductivity and permeability resulting from chemical consolidation may be maintained over a period of at least several days and under high closure stress values.

Although chemical consolidation has been utilized for hardening sandstone formations and other siliceous formations, such techniques have been sparsely utilized for carbonate formations and not by the approach specified herein. The concept of chemical consolidation in sandstone and other siliceous formations is based upon deposition of a mineral phase within the existing formation matrix, thereby binding individual rock grains together to promote strengthening or hardening. In the present disclosure, chemical consolidation of a carbonate matrix may be achieved through direct alteration of the carbonate mineralogy by converting a carbonate mineral into a harder mineral through a dissolution-precipitation reaction. In particular, the carbonate mineral may be treated with an ammonium phosphate salt in the present disclosure to convert at least a portion of the carbonate mineral into a hydroxyapatite mineral to accomplish the foregoing. Advantageously, conversion of a carbonate mineral into a hydroxyapatite mineral may be accomplished over short time periods under mild reaction conditions, as discussed hereinafter. Higher temperature conditions may further increase the effectiveness of converting a carbonate mineral into a hydroxyapatite mineral.

Surprisingly, the hydroxyapatite mineral produced according to the disclosure herein may allow increased conductivity and permeability to be maintained even under high closure stress values. Moreover, the increased conductivity and permeability may be retained under the high closure stress values over extended time periods, such as several days or longer. Both of these features may facilitate extended production of hydrocarbons from a subterranean formation.

As used herein, the terms “proppant” or “proppant particulate” refers to particles mixed with hydraulic fracturing fluids to hold fractures open after the hydraulic pressure generated during hydraulic fracturing is relieved.

As used herein, the term “matrix acidizing” refers to the treatment of a subterranean formation with a fluid containing an acid that reacts with the formation matrix. A “fluid” may include liquids, gases, or both liquids and gases.

As used herein, the term “flow pathways” refers to fractures, asperities (wormholes), or any combination thereof.

As used herein, the term “closure stress” refers to the pressure within a flow pathway that tends to promote narrowing or closure of the flow pathway.

Methods for maintaining the conductivity of a subterranean formation comprising a carbonate mineral following stimulation thereof are described herein. The subterranean formation may be stimulated by performing matrix acidizing, hydraulic fracturing, or acid-fracturing upon the subterranean formation. Stimulating the subterranean formation may form a plurality of flow pathways within the subterranean formation, through which hydrocarbon (e.g., crude oil and/or gas) may flow in the course of being produced from a wellbore. Increasing the conductivity of the flow pathways within the subterranean formation may occur by chemical consolidation of the carbonate mineral using an ammonium phosphate salt in an aqueous carrier fluid.

More specifically, methods of the present disclosure may comprise: stimulating a subterranean formation comprising a carbonate mineral by performing matrix acidizing. hydraulic fracturing, or acid-fracturing upon the subterranean formation to form a plurality of flow pathways; after forming the plurality of flow pathways, introducing an ammonium phosphate salt in an aqueous carrier fluid into the subterranean formation; and interacting the carbonate mineral with the ammonium phosphate salt to convert at least a portion of the carbonate mineral into a hydroxyapatite mineral. The subterranean formation, after interacting with the ammonium phosphate salt, may have an increased conductivity relative to the subterranean formation, after stimulating but before interacting with the ammonium phosphate salt, under a closure stress of about 600 psi or greater. Additionally or alternately, the conductivity of the subterranean formation, after interacting with the ammonium phosphate salt, may vary about 5% or less over a period of 2 days to 7 days under a closure stress of about 600 psi or above.

In the disclosure herein, the subterranean formation may comprise a carbonate mineral, preferably a carbonate mineral comprising calcium (e.g., calcium carbonate) having a Mohs hardness of 3. Examples of carbonate minerals comprising calcium that may be strengthened through the disclosure herein may include, but are not limited to, calcite, aragonite, vaterite, dolomite, the like, and any combination thereof. The calcium carbonate may be in the form of limestone, chalk, marble, or any combination thereof.

In the disclosure herein, the carbonate mineral may be converted to a hydroxyapatite mineral by interacting the carbonate mineral with an ammonium phosphate salt. Suitable ammonium phosphate salts may include, for example, diammonium hydrogen phosphate, ammonium dihydrogen phosphate, or a combination thereof. Preferably, the ammonium phosphate salt comprises, consists of, or consists essentially of diammonium hydrogen phosphate. The ammonium phosphate salt (e.g., diammonium hydrogen phosphate), may convert the carbonate mineral (e.g., calcium carbonate) into a hydroxyapatite mineral via a dissolution-precipitation reaction. Hydroxyapatite is a phosphate mineral having a Mohs hardness of 5. Therefore, converting a carbonate mineral into a hydroxyapatite mineral may increase the hardness of the subterranean formation, which may facilitate increased stability and conductivity retention under high closure stress values. The dissolution-precipitation reaction of calcium carbonate and diammonium hydrogen phosphate occurs according to Reaction 1.

10CaCO₃+6(NH₄)₂HPO₄+2H₂O→Ca₁₀(PO₄,CO₃)₆(OH,CO₃)₂+6(NH₄)₂CO₃+4H₂CO₃ Reaction 1

in which CaCO₃ is calcium carbonate and (NH₄)₂HPO₄ is ammonium hydrogen phosphate. The product of Reaction 1 is written to show that there may be carbonate defects within the hydroxyapatite structure in some cases. Ammonium carbonate ((NH₄)₂CO₃) is soluble and does not precipitate with the hydroxyapatite. Other phosphate minerals that may be formed by a dissolution-precipitation of calcium carbonate and diammonium hydrogen phosphate may include a dicalcium phosphate mineral and/or an octacalcium phosphate dihydrate mineral. These species may form as intermediates during the precipitation of hydroxyapatite in some cases.

The ammonium phosphate salt, such as diammonium hydrogen phosphate, may be introduced to the subterranean formation in an aqueous carrier fluid. Suitable aqueous carrier fluids may include, for example, at least one of fresh water (e.g., stream water, lake water, or municipal treated water), salt water (aqueous salt solutions), sea water, brine, non-potable water such as gray water or industrial process water, formation water, produced water, well water, filtered water, distilled water, or any combination thereof. Produced water may include formation water obtained from the subterranean formation or flowback water produced following stimulation of the subterranean formation with an appropriate treatment fluid. As used herein, the term “brine” refers to a saturated aqueous salt solution. An “aqueous salt solution” has a salt concentration (salinity) less than that of brine. Any of the foregoing aqueous carrier fluids may be used, provided that the aqueous carrier fluid does not contain a component that is incompatible with the ammonium phosphate salt, such as to cause precipitation thereof.

The ammonium phosphate salt, such as diammonium hydrogen phosphate, may have a concentration in the aqueous carrier fluid of about 0.1 M to about 5 M, or about 0.1 M to about 1 M, or about 0.5 M to about 1.5 M, or about 1 M to about 2 M, or about 1.5 M to about 2.5 M, or about 2 M to about 3 M, or about 2.5 M to about 3.5 M, or about 3 M to about 4 M, or about 3.5 M to about 4.5 M, or about 4 M to about 5 M, or about 0.1 M to about 2 M, or about 1 M to about 3 M. A maximum concentration may be dictated by the solubility limit of the ammonium phosphate salt in a given carrier fluid at a specified temperature.

In addition to methods that produce a hydroxyapatite mineral to promote increased hardness and, subsequently, retained conductivity of the subterranean formation following stimulation, other treatments may be suitable for converting a carbonate mineral into a second mineral (other than hydroxyapatite) with an increased hardness. Suitable treatments may include, but are not limited to, tetraethyl orthosilicate, calcium hydroxide, calcium alkoxides, zinc sulfate, zinc nitrate, zinc chloride, barium chloride, sodium fluoride, ammonium fluoride, hydrofluoric acid, cadmium nitrate tetrahydrate, cadmium chloride, lead (II) nitrate, bacteria (e.g., Myxococcus xanthus and/or Bacillus sphaericus), the like, and any combination thereof.

The presence of the second mineral (e.g., hydroxyapatite) formed by converting the carbonate mineral with a suitable reagent (e.g., diammonium hydrogen phosphate) may be confirmed using techniques including, but not limited to, X-ray diffraction (XRD), scanning electron microscopy (SEM), energy-dispersive X-ray spectroscopy (EDS), the like, and any combination thereof. For example, XRD and/or SEM may be used to visualize the surface of the subterranean formation (or a core sample obtained therefrom) before and after the introduction of a treatment containing the ammonium phosphate salt. The surface of the subterranean formation may be physically altered upon conversion of the carbonate mineral into the second mineral (e.g., hydroxyapatite). Techniques such as EDS may be used to confirm the presence of new ions (e.g., phosphorus) in the subterranean formation following the introduction of the treatment.

Conversion of the carbonate mineral into a hydroxyapatite mineral (or other mineral having an increased hardness relative to the carbonate mineral) may take place in conjunction with a stimulation operation to form a plurality of flow pathways (e.g., fractures or wormholes) in the formation matrix. Suitable stimulation operations may include hydraulic fracturing to produce fractures and/or matrix acidizing to produce wormholes. Generally, the simulation operation may be performed before converting the carbonate mineral into the hydroxyapatite mineral. Conversion of the carbonate mineral into the hydroxyapatite mineral may be conducted following a stimulation operation before the permeability and conductivity have had a chance to decrease (e.g., due to at least partial closure or collapse of flow pathways within the formation matrix), such as after hydraulic fracturing pressure has been released.

Hydraulic fracturing may be performed to increase permeability of the subterranean formation and increase the amount of hydrocarbons produced therefrom. The increased permeability and conductivity generated during the fracturing operation may be retained following stimulation through formation of a hydroxyapatite mineral according to the disclosure herein. During a fracturing operation, a hydraulic fracturing fluid (typically containing a plurality of proppant particulates and various optional components to adjust the density and viscosity of the fracturing fluid) are pumped into the subterranean formation above a fracture gradient pressure thereof. The hydraulic pressure causes fractures to open in the subterranean formation, thereby increasing permeability and conductivity within the formation matrix. Once the hydraulic pressure is released, the proppant particulates become disposed in the fractures and maintain the fractures in an open condition, provided that the formation matrix has sufficient strength to limit proppant embedment. The material comprising the proppant particulates may be chosen based on the particular application and characteristics desired, such as the depth of the subterranean formation in which the proppant particulates will be placed and the crush strength of the proppant particulates under reservoir conditions at the specified subterranean depth. The chemistry of the subterranean formation may also be considered when selecting suitable proppant particulates in some cases. Optionally, a protective and/or hardening coating, such as a resin or epoxy coating, may be applied to the proppant particulates to modify or customize the density or mechanical strength of a selected base proppant material.

Hydraulic fracturing may include three main stages: a pad fluid stage, a proppant-containing fluid stage, and an overflush fluid stage. The pad fluid stage may include pumping a pad fluid into a subterranean formation, which may initiate and propagate fractures in the subterranean formation. Typically, the pad fluid stage may lack proppant particulates. The proppant-containing fluid stage may include pumping a proppant-containing fluid into the fractures of the formation, which may facilitate lodging of proppant particulates in the fractures and creating conductive fractures through which hydrocarbons may flow. The overflush fluid stage may include pumping an overflush fluid into the fractures to push the proppant particulates deeper inside the fractures. Following the fracturing operation, the hydraulic pressure may be released, which may lead to at least partial closure of the fractures if proppant particulates are not present in the fractures or if proppant embedment occurs due to insufficient stability of the formation matrix.

Matrix acidizing may similarly be performed to increase permeability and conductivity of the subterranean formation and increase the amount of hydrocarbons produced therefrom. During matrix acidizing, an acidizing fluid may be employed to stimulate the subterranean formation by dissolving at least a portion of the carbonate mineral in the formation matrix to promote wormhole generation therein. In a carbonate formation, the acid in the acidizing fluid may dissolve portions of the rock formation matrix, thereby increasing porosity of the formation matrix.

Suitable acidizing fluids may comprise an aqueous acid solution, which may comprise any one or a combination of one or more mineral acids (strong acid) and/or one or more organic acids. The term “strong acid” refers to any acid with a logarithmic acid dissociation constant (pKₐ) value that is less than or equal to 1.0, and the term “weak acid” refers to any acid with a pKₐ value that is greater than 1.0. Mineral acids (strong acids) that may be present in an acidizing fluid for a carbonate formation may include, but are not limited to, hydrochloric acid, hydrobromic acid, nitric acid, the like, and any combination thereof. Organic acids that may be present in an acidizing fluid for a carbonate formation may include, but are not limited to, acetic acid, formic acid, methanesulfonic acid, trifluoromethanesulfonic acid, trifluoroacetic acid, the like, and any combination thereof. In non-limiting examples, the aqueous acid solution may comprise one or more acids at a concentration ranging from about 10 wt % to about 70 wt %, or about 25 wt % to about 60 wt %, or about 30 wt % to about 50 wt %, or about 45 wt % to about 60 wt %, or about 35 wt % to about 50 wt %, based on total mass of the acidizing fluid. Any combination of mineral acids and organic acids may be present.

Suitable acidizing operations may include pumping a displacement fluid, also referred to as a flush fluid, into the subterranean formation after the acidizing fluid. The displacement fluid may force the acidizing fluid deeper into the subterranean formation and promote wormhole formation therein to increase the permeability and conductivity of the formation matrix. The displacement fluid may be pumped until all, or nearly all, of the acidizing fluid has been forced into the subterranean formation. In some cases, an acidizing fluid may be incompatible with fluids already present within the subterranean formation, such as a drilling fluid. If there is an issue with fluid incompatibility, a spacer fluid may be pumped into the subterranean formation prior to introducing the acidizing fluid. The spacer fluid may provide separation between the fluid already present within the subterranean formation and the acidizing fluid being introduced thereto.

As discussed herein, the process of stimulating a subterranean formation comprising a carbonate mineral may weaken the formation matrix and lead to proppant embedment or other types of stress-induced closures following a stimulation operation. Treatment of the subterranean formation following stimulation via chemical consolidation to form a hydroxyapatite mineral according to the disclosure herein may improve the hardness of the subterranean formation and maintain permeability and conductivity of the subterranean formation following a stimulation operation. To determine whether the hardness of the subterranean formation has been increased, the hardness of the subterranean formation may be evaluated before and after contacting the ammonium phosphate salt with the formation matrix and converting the carbonate mineral into a hydroxyapatite mineral. Suitable testing procedures to evaluate the increase in strength may include a Brazilian disc test, an unconfined compression test, an ultrasonic pulse velocity test, micro-drilling, a scratch test, indentation (e.g., using the Brinell hardness scale), impulse hammering, the like, and any combination thereof. The testing procedure for determining Brinell hardness is specified in the Examples below. As non-limiting examples, the subterranean formation may exhibit an increase in hardness (as measured by impulse hammering) of about 100% to about 500%, or about 100% to about 400%, or about 100% to about 300%, or about 100% to about 200%, or about 200% to about 500%, or about 200% to about 400%, or about 200% to about 300%, or about 300% to about 500%, or about 300% to about 400%, or about 400% to about 500% upon converting at least a portion of the carbonate mineral into a hydroxyapatite mineral using diammonium hydrogen phosphate according to the disclosure herein.

Surprisingly, increased hardness of the subterranean formation may not significantly affect roughness of the subterranean formation surface and/or of the flow pathways formed therein upon interacting the carbonate mineral with the ammonium phosphate salt. In non-limiting examples, surface roughness, as measured with a Kruss surface roughness analyzer, may change by about 10% or less, or about 5% or less, or about 4% or less, or about 3% or less, or about 2% or less, or about 1% or less, or about 0.9% or less, or about 0.8% or less, or about 0.7% or less, or about 0.6% or less, or about 0.5% or less, or about 0.4% or less, or about 0.3% or less, or about 0.2% or less, or about 0.1% or less following conversion of the carbonate mineral to the hydroxyapatite mineral.

Treatment of the subterranean formation following stimulation through chemical consolidation to form a hydroxyapatite mineral according to the disclosure herein may improve the hardness of the subterranean formation and maintain or increase the permeability and conductivity generated during the stimulation operation, even under high closure stress values and over extended periods of time. As non-limiting examples, the subterranean formation may exhibit improved conductivity, as measured relative to the subterranean formation following stimulation but without conversion of a carbonate mineral to a hydroxyapatite mineral according to the disclosure herein, under closure stresses of about 600 psi or greater, or about 700 psi or greater, or about 800 psi or greater, or about 900 psi or greater, or about 1,000 psi or greater. For instance, increased permeability and conductivity may be realized within closure stress values ranging from about 600 psi to about 1000 psi, or about 700 psi to about 900 psi, or about 650 psi to about 950 psi. In addition or alternately, the permeability and conductivity may remain nearly constant over a period of at least several days following chemical consolidation after a stimulation operation according to the disclosure herein. In non-limiting examples, the conductivity of the subterranean formation my vary by about 5% or less, or about 4% or less, or about 3% or less, or about 2% or less, or about 1% or less over a period of 2 days to 7 days under a closure stress of about 600 psi or greater after converting a carbonate mineral into a hydroxyapatite mineral using an ammonium phosphate salt according to the disclosure herein.

Embodiments disclosed herein include:

A. Methods for stimulating a subterranean formation and maintaining the conductivity therein. The methods comprise: stimulating a subterranean formation comprising a carbonate mineral by performing matrix acidizing, hydraulic fracturing, or acid-fracturing upon the subterranean formation to form a plurality of flow pathways; after forming the plurality of flow pathways, introducing an ammonium phosphate salt in an aqueous carrier fluid into the subterranean formation; and interacting the carbonate mineral with the ammonium phosphate salt to convert at least a portion of the carbonate mineral into a hydroxyapatite mineral; wherein the subterranean formation, after interacting with the ammonium phosphate salt, has an increased conductivity relative to the subterranean formation, after stimulating but before interacting with the ammonium phosphate salt, under a closure stress of about 600 psi or greater.

B. Methods for stimulating a subterranean formation and maintaining the conductivity therein over a period of time. The methods comprise: stimulating a subterranean formation comprising a carbonate mineral by performing matrix acidizing, hydraulic fracturing, or acid-fracturing upon the subterranean formation to form a plurality of flow pathways; after forming the plurality of flow pathways, introducing an ammonium phosphate salt in an aqueous carrier fluid into the subterranean formation; and interacting the carbonate mineral with the ammonium phosphate salt to convert at least a portion of the carbonate mineral into a hydroxyapatite mineral; wherein the subterranean formation, after interacting with the ammonium phosphate salt, has an increased conductivity relative to the subterranean formation, after stimulating but before interacting with the ammonium phosphate salt, and the conductivity of the subterranean formation, after interacting with the ammonium phosphate salt, varies by about 5% or less over a period of 2 days to 7 days under a closure stress of about 600 psi or greater.

Each of embodiments A and B may have one or more of the following additional elements in any combination:

Element 1: wherein the carbonate mineral comprises calcium carbonate.

Element 2: wherein the calcium carbonate is in the form of limestone, chalk, marble, or any combination thereof.

Element 3: wherein the ammonium phosphate salt comprises diammonium hydrogen phosphate.

Element 4: wherein the conductivity of the subterranean formation varies by about 5% or less over a period of 2 days to 7 days under the closure stress after interacting with the ammonium phosphate salt.

Element 5: wherein a hardness of the subterranean formation increases by about 100% to about 500% after interacting with the ammonium phosphate salt.

Element 6: wherein the aqueous carrier fluid comprises fresh water, salt water, sea water, brine, non-potable water, formation water, produced water, well water, filtered water, distilled water, or any combination thereof.

Element 7: wherein a concentration of the ammonium phosphate salt in the aqueous carrier fluid is about 0.1 M to about 5 M.

Element 8: wherein a roughness of the plurality of flow pathways is substantially unchanged after interacting the carbonate mineral with the ammonium phosphate salt.

By way of non-limiting example, exemplary combinations applicable to A and B include, but are not limited to: 1 and 2; 1-3; 1 and 4; 1, 2, and 4; 1 and 5; 1, 2, and 5; 1 and 6; 1, 2, and 6; 1, and 7; 1, 2, and 7; 1 and 8; 1, 2, and 8; 3 and 4; 3 and 5; 3 and 6; 3 and 7; 3, and 8; 3-5; 4 and 5; 4 and 6; 4 and 7; 4 and 8; 5 and 6; 5 and 7; 5 and 8; 6 and 7; 6 and 8; and 7 and 8.

The present disclosure is further directed to the following non-limiting clauses:

Clause 1. A method comprising:
stimulating a subterranean formation comprising a carbonate mineral by performing matrix acidizing, hydraulic fracturing, or acid-fracturing upon the subterranean formation to form a plurality of flow pathways;
after forming the plurality of flow pathways, introducing an ammonium phosphate salt in an aqueous carrier fluid into the subterranean formation; and
interacting the carbonate mineral with the ammonium phosphate salt to convert at least a portion of the carbonate mineral into a hydroxyapatite mineral;
   wherein the subterranean formation, after interacting with the ammonium phosphate salt, has an increased conductivity relative to the subterranean formation, after stimulating but before interacting with the ammonium phosphate salt, under a closure stress of about 600 psi or greater.

Clause 2. The method of clause 1, wherein the carbonate mineral comprises calcium carbonate.

Clause 3. The method of clause 2, wherein the calcium carbonate is in the form of limestone, chalk, marble, or any combination thereof.

Clause 4. The method of any one of clauses 1-3, wherein the ammonium phosphate salt comprises diammonium hydrogen phosphate.

Clause 5. The method of any one of clauses 1-4, wherein the conductivity of the subterranean formation varies by about 5% or less over a period of 2 days to 7 days under the closure stress after interacting with the ammonium phosphate salt.

Clause 6. The method of any one of clauses 1-5, wherein a hardness of the subterranean formation increases by about 100% to about 500% after interacting with the ammonium phosphate salt.

Clause 7. The method of any one of clauses 1-6, wherein the aqueous carrier fluid comprises fresh water, salt water, sea water, brine, non-potable water, formation water, produced water, well water, filtered water, distilled water, or any combination thereof.

Clause 8. The method of any one of clauses 1-7, wherein a concentration of the ammonium phosphate salt in the aqueous carrier fluid is about 0.1 M to about 5 M.

Clause 9. The method of any one of clauses 1-8, wherein a roughness of the plurality of flow pathways is substantially unchanged after interacting the carbonate mineral with the ammonium phosphate salt.

Clause 10. A method comprising:
stimulating a subterranean formation comprising a carbonate mineral by performing matrix acidizing, hydraulic fracturing, or acid-fracturing upon the subterranean formation to form a plurality of flow pathways;
after forming the plurality of flow pathways, introducing an ammonium phosphate salt in an aqueous carrier fluid into the subterranean formation; and
interacting the carbonate mineral with the ammonium phosphate salt to convert at least a portion of the carbonate mineral into a hydroxyapatite mineral;
   wherein the subterranean formation, after interacting with the ammonium phosphate salt, has an increased conductivity relative to the subterranean formation, after stimulating but before interacting with the ammonium phosphate salt, and the conductivity of the subterranean formation, after interacting with the ammonium phosphate salt, varies by about 5% or less over a period of 2 days to 7 days under a closure stress of about 600 psi or greater.

Clause 11. The method of clause 10, wherein the carbonate mineral comprises calcium carbonate.

Clause 12. The method of clause 11, wherein the calcium carbonate is in the form of limestone, chalk, marble, or any combination thereof.

Clause 13. The method of any one of clauses 10-12, wherein the ammonium phosphate salt comprises diammonium hydrogen phosphate.

Clause 14. The method of any one of clauses 10-13, wherein a hardness of the subterranean formation increases by about 100% to about 500% after interacting with the ammonium phosphate salt.

Clause 15. The method of any one of clauses 10-14, wherein the aqueous carrier fluid comprises fresh water, salt water, sea water, brine, non-potable water, formation water, produced water, well water, filtered water, distilled water, or any combination thereof.

Clause 16. The method of any one of clauses 10-15, wherein a concentration of the ammonium phosphate salt in the aqueous carrier fluid is about 0.1 M to about 5 M.

Clause 17. The method of any one of clauses 10-16, wherein a roughness of the plurality of flow pathways is substantially unchanged after interacting the carbonate mineral with the ammonium phosphate salt.

To facilitate a better understanding of the embodiments described herein, the following examples of various representative embodiments are given. In no way should the following examples be read to limit, or to define, the scope of the present disclosure.

### EXAMPLES

### Example 1

Samples of Indiana limestone and Austin chalk were separately treated with diammonium hydrogen phosphate to evaluate the increase in hardness resulting from hydroxyapatite formation. In brief, samples of 3.8 cm×7.6 cm (1.5 inches×3 inches) were fully immersed in a 1 M solution of diammonium hydrogen phosphate in water for 120 hours under ambient conditions. After allowing the samples to dry, the Brinell hardness was measured on both sides of each sample, with measurements being made at five different spots on each side.

The Brinell hardness was determined using a Tinius Olsen FH-9 testing apparatus. Indentations were made using a 62.5 kilogram-force for chalk samples and a 125 kilogram-force for limestone samples, each using a 5 mm indenter ball. After indentation, the indentations were inspected under a microscope to determine the indentation diameter. The applied forces and diameters were then used to calculate the Brinell hardness.

The measured hardness values at each location were compared to the hardness before treatment. The minimum, maximum, and average Brinell hardness values for each sample are also tabulated in Table 1. On average, treatment with diammonium hydrogen phosphate increased the Brinell hardness of the limestone sample by 7% and the chalk sample by 28%. In Table 1, HB represents Hardness Brinell, which is unitless.

TABLE 1

| | |
|---|---|
| Limestone | Chalk |

| | Before | After | Before | After |
|---|---|---|---|---|
| | Treatment | Treatment | Treatment | Treatment |
| Minimum | 24.7 | 29.8 | 6.3 | 7.7 |
| Hardness | | | | |
| [HB] | | | | |
| Maximum | 33.2 | 36.7 | 9.8 | 12.8 |
| Hardness | | | | |
| [HB] | | | | |
| Average | 30.8 | 32.9 | 8.1 | 10.4 |
| Hardness | | | | |
| [HB] | | | | |
| Average | — | 7% | — | 28% |
| Percent | | | | |
| Increase | | | | |

Scanning electron microscopy (SEM) images of the limestone and chalk samples showed the presence of hydroxyapatite crystals on a majority of the surface of the samples. EDS analyses were conducted at locations upon the surface of the limestone sample where hydroxyapatite conversion was either visually complete or visually incomplete. For location P1, which showed no visual conversion to hydroxyapatite, EDS analysis confirmed lack of phosphorus (and consequently hydroxyapatite). At location P2, which did show visual conversion to hydroxyapatite, EDS analysis showed the presence of phosphorus (and likely the presence of hydroxyapatite). The EDS analyses are summarized in Table 2.

TABLE 2

| | Atomic Percentages | | | |
|---|---|---|---|---|
| Point | Carbon [%] | Oxygen [%] | Phosphorus [%] | Calcium [%] |
| P1 | 16.3 | 47.5 | 0 | 25 |
| P2 | 3.6 | 14.5 | 2.3 | 64.6 |

Example 2. Eight Austin chalk samples were acid-etched by injection of 10 vol % hydrochloric acid over the surface of the chalk samples in an API acid fracture conductivity assessment system. The acid was applied at a flow rate of 500 cm³/min for 10 minutes to form wormholes within the samples. The samples were flushed with sequential injections of brine and deionized water following the acid etching process. After identifying samples having similar initial hardness values, four of the chalk samples were subsequently treated with 1 M diammonium hydrogen phosphate (DAP) in water under a pressure of 1,000 psi and 75° C. to mimic reservoir conditions. After the treatment with DAP, the treated samples were oven-dried. The hardness of the chalk samples before and after the DAP treatment was measured using an impulse hammering technique collected over 30 points on each of the chalk samples. Table 3 shows the hardness measurements for two of the chalk samples.

TABLE 3

| | Sample 1 | | Sample 2 | |
|---|---|---|---|---|
| | Hardness | Hardness | Hardness | Hardness |
| | before DAP | after DAP | before DAP | after DAP |
| | treatment | treatment | treatment | treatment |
| | (GPa) | (GPa) | (GPa) | (GPa) |
| Mean | 2.36 | 7.47 | 1.57 | 6.77 |
| Standard deviation | 0.61 | 1.51 | 0.34 | 1.31 |
| Minimum | 1.55 | 4.62 | 1.00 | 3.56 |
| Maximum | 4.05 | 11.01 | 2.51 | 9.19 |
| Range | 2.49 | 6.39 | 1.51 | 5.63 |

On average, the DAP treatment increased the hardness of the chalk samples by approximately 217% for Sample 1 and 331% for Sample 2.

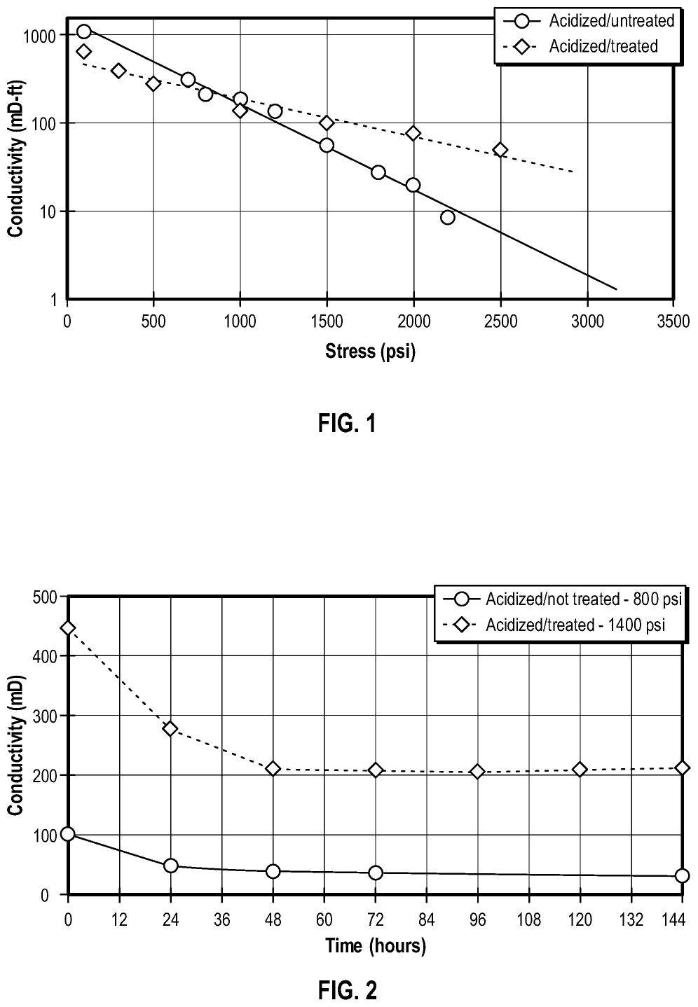

Conductivity of the acid-etched chalk samples was measured using nitrogen gas. Varying amounts of closure stress were applied to the chalk samples while nitrogen was pumped through the samples at flow rates ranging from 200 cm³/min to 350 cm³/min with a 50 cm³/min step increase. FIG. 1 is a graph of conductivity as a function of closure stress for an acid-etched Austin chalk sample before and after treatment with diammonium hydrogen phosphate. The initial conductivity of the untreated sample was higher than that of the DAP-treated sample, measuring over 1,000 mD-ft. However, the sample treated with DAP exhibited higher conductivity values under closure stresses of 600 psi or greater. For conductivity measurements collected over several days, a constant amount of stress was applied to the chalk samples over six days, during which time the conductivity of the samples was measured daily.

FIG. 2 is a graph of conductivity as a function of time for an acid-etched Austin chalk sample before and after treatment with diammonium hydrogen phosphate under various closure stresses. Under 800 psi of closure stress, the untreated chalk sample exhibited negligible conductivity, whereas the DAP-treated sample maintained high conductivity values even under a higher closure stress of 1400 psi. These results indicate that treating chalk, a carbonate mineral, with DAP may sustain conductivity over both the short-term and the long-term.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains,” “containing.” “includes.” “including,” “comprises,” and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, clement, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

1.-9. (canceled)

10. A method comprising:
stimulating a subterranean formation comprising a carbonate mineral by performing matrix acidizing, hydraulic fracturing, or acid-fracturing upon the subterranean formation to form a plurality of flow pathways;
after forming the plurality of flow pathways, introducing an ammonium phosphate salt in an aqueous carrier fluid into the subterranean formation; and
interacting the carbonate mineral with the ammonium phosphate salt to convert at least a portion of the carbonate mineral into a hydroxyapatite mineral;
wherein the subterranean formation, after interacting with the ammonium phosphate salt, has an increased conductivity relative to the subterranean formation, after stimulating but before interacting with the ammonium phosphate salt, and the conductivity of the subterranean formation, after interacting with the ammonium phosphate salt, varies by about 5% or less over a period of 2 days to 7 days under a closure stress of about 600 psi to about 1000 psi.

11. The method of claim 10, wherein the carbonate mineral comprises calcium carbonate.

12. The method of claim 11, wherein the calcium carbonate is in a form of limestone, chalk, marble, or any combination thereof.

13. The method of claim 10, wherein the ammonium phosphate salt comprises diammonium hydrogen phosphate.

14. The method of claim 10, wherein a hardness of the subterranean formation increases by about 100% to about 500% after interacting with the ammonium phosphate salt.

15. The method of claim 10, wherein the aqueous carrier fluid comprises fresh water, salt water, sea water, brine, non-potable water, formation water, produced water, well water, filtered water, distilled water, or any combination thereof.

16. The method of claim 10, wherein a concentration of the ammonium phosphate salt in the aqueous carrier fluid is about 0.1 M to about 5 M.

17. The method of claim 10, wherein a roughness, as measured with a Kruss surface roughness analyzer, of the plurality of flow pathways is substantially unchanged after interacting the carbonate mineral with the ammonium phosphate salt.
